(19) United States
(12) Patent Application Publication
(10) Pub. No.: US 2005/0043859 A1
(43) Pub. Date: Feb. 24, 2005

(54) Modular uninterruptible power supply system and control method thereof

(76) Inventors: Chia-Ming Tsai, Yung-He City (TW); Shou-Long Tian, Baoan Shenzhen (CN); Gang Liu, Baoan Shenzhen (CN); Han-Sheng Luo, Baoan Shenzhen (CN); Yue-Feng Yang, Baoan Shenzhen (CN)

Correspondence Address: Alan D. Kamrath;Rider Bennett, LLP, Suite 2000, 333 South Seventh Street, Minneapolis, MN, 55402, US

(21) Appl. No.: 10/640,555

(22) Filed: Aug. 13, 2003

(51) Int. Cl. H02J 7/00

(52) U.S. Cl. 700/286; 307/65

(57) ABSTRACT

An uninterruptible power supply (UPS) system and control method thereof is provided. The system contains a plurality of UPS modules connected in parallel, and each module is equipped with full uninterruptible power supply capabilities, and redundant control logic and functional capabilities for self-initiated role detection, master arbitration and parallel processing. The UPS system is self-initialized through a master arbitration process to elect a virtual master among the peers for maintaining inter-unit signaling between parallel UPS modules and controlling the parallel operation. If the virtual master is failed, other UPS modules will initiate the role detection and master arbitration to re-elect a new virtual master. Parallel operation is accomplished without any external controller; the system can be operated with only one UPS module; distribution of adequate resource to each module is properly arranged, thus the risks of system-level single-point failure are much reduced.

### BACKGROUND OF THE INVENTION

1. Field of the Invention

The present invention relates to a modular uninterruptible power supply system and control method thereof, in particular to a system of parallel UPS modules all with full uninterruptible power supply capabilities, and identical control logic and functional capabilities for initiating role detection dynamically and electing a virtual master through the arbitration process to control the parallel operation of UPS modules. The system design has incorporated the characteristics of both centralized control and distributed processing by dispensing with a dedicated control module, and is able to operate with one or more UPS modules in parallel, providing fault tolerance and maximum redundancy, and reducing the risks of system-level single point failure to minimum possibility to the emergent and sensitive load.

2. Description of Related Arts

Computers and networking have become essential tools for enhancing the economic and technological development in many countries. To keep the operation of computers and networks working in normal operating conditions, there has to be a continuous supply of electrical power. As is commonly known, high-tech systems cannot tolerate even a brief loss of power, which could cause severe data loss for the data processing equipment and breakdown of the data communication systems. To prevent such accidents, companies and individual users see the benefits of having an uninterruptible power supply to protect their installation and the operation results. Therefore, the demand for the uninterruptible power supply is increasing steadily.

An uninterruptible power supply receives AC and DC input power and provides an AC output power to a load. In general, the AC input power is generally provided by the utility companies or the power generators, whilst the DC power is generally supplied by the batteries. The AC output power provides the necessary electrical power for driving the electrical equipment, and the controller controls the systems. If the sensitive equipment is installed with a UPS, when the main line is failed, the power source will be automatically switched to the secondary source. The DC power from the battery is used to maintain a continuous power supply to the load.

A UPS offers line filtering and power regulation for a main line in normal conditions and a secondary power source when the supply from the main line is interrupted. When the AC output is normal, the system input of the UPS is connected to a filter for filtering out line noises, and then through an AC/DC converter to an DC bus for saving the DC power, and then the DC bus is connected to a DC/AC inverter through an optional output filter to provide the necessary power to the load.

When the AC input is interrupted, the DC power will be drawn from the secondary source passing through a DC/DC converter to the DC bus replacing the AC input by converting DC input power to DC Bus, and then further through a DC/AC inverter generating AC power connected to the load. This type of UPS usually also has a charger if the secondary DC source are batteries to recharge the batteries once the main line is returned to the normal supply conditions.

The conventional structure of a UPS is only able to provide a continuous supply of electrical power for the operating loads, however, it cannot satisfy the continuously increasing requirements of the load. If the load capacity is varied or increased, the original UPS may not be able to handle the new demands. There may also be stringent demand for fault tolerance, which would be beyond the provision of the conventional UPS. The answer to these problems is a modular UPS system. The modular system design has the advantages of scalability and redundancy, which are becoming a trend for the future.

Increasing the number of UPS units to satisfy the expansion and replacement needs will encounter a problem in parallel operation. The control technology has to take care of the cross conduction current from UPS modules with different output power as they are connected in parallel. Excessive cross conduction current will lead to system breakdown. The related control technology for a power supply system has been widely discussed in the academic and industrial fields and they are considered key issues for a reliable parallel system.

Modular UPS for parallel operation can be generally classified basing on their control methods. The first class of modular UPS systems are built with the wire bus control, and the second class of UPS systems employ the wireless control. Both designs have been sufficiently disclosed by prior arts. In one case a parallel redundant power supply system is built by using the AC output voltage level to coordinate load sharing, and in another case the load balancing and the reduction in cross conduction current are achieved without the need for common control circuitry between the parallel inverters.

For implementations using the wire bus control, a sync clock signal is used to synchronize the output voltage phase across all UPS modules, and with inter-unit signaling of loading status between UPS modules load balancing can be achieved, but the results are not satisfactory. The wire bus control method for controlling parallel operation could cause system-level single point failure.

In one prior art U.S. Pat. No. 6,121,695, each UPS module is considered as an independent UPS function, but when they are put into a housing for parallel connection each UPS module needs to be respectively connected to a controller for controlling parallel operation. In addition, the DC bus is interconnected by all parallel UPS modules. If the DC bus is damaged, the whole system will not be able to operate, representing a typical case of the system-level single point failure. The proposed UPS modules therefore are not truly independent operation units. Besides, since the batteries of the UPS modules are not connected in parallel, the unit discharging time for different batteries may not be the same due to their inherent discharging characteristics, and the discharging time, in this case, cannot be extended by adding optional batteries. A majority rule decides for all UPS modules whether to switch to main line or battery output. The control signals exchanged between individual UPS modules are decided by an average impedance value, and the configuration of UPS modules cannot be modified by external means. There is no controller to coordinate the system, even the situation is very emergency, the system is still just judged by a so-called “majority rule” regardless of the possibility of system-level single-point failure. Thus the important and sensitive load is under a dangerous condition.

Also, in still another prior art U.S. Pat. No. 6,201,319, a main intelligence module (MIM) is employed for managing the power modules, and a redundant intelligence module (RIM) for the redundant control. However, these idling units in normal conditions will create unnecessary waste of system resources. The system is only equipped with power modules and external controllers. The power module is not designed with full uninterruptible power supply capabilities, some of the important characteristics are put in MIM, and only some of them are redundant in RIM. For example, the important operation data such as input voltage, frequency, output voltage, frequency, and current are centrally collected and stored in the MIM. The system could only enhance the redundancy of power module thus avoid the module-level failure. Moreover, the connected wired between the MIM or RIM and the power modules and some signals only designed in MIM are not redundant, if they are inoperative, the result will turn to be a system-level single point failure.

Lastly, still another prior art U.S. Pat. No. 6,396,170 uses a virtual controller model. Although it could avoid the loss of RIM reducing the risks of a system-level single point failure, the system simultaneously creates a master and a vice master in two separate UPS modules. If there is only one UPS module in the system, then the system will not be able to function. Moreover, the use of a common sync line also increases the risks of system-level single point failure. If this sync line is defeated, the total system is shut-down. Also, the proposed system architecture for the redundancy management (RMB) would require a complicated procedure to determine the direction of input and output, and to elect the virtual master or vice virtual master. Also, the sync line needs a high level system interrupt and a fast response management model, which wastes large resources on that, could use alternative method to get the same result. If any UPS module is down or experiences interfacing problems, the unit cannot initiate a mode switch for itself, and instead the master will order all UPS modules to switch to a default mode leading to even more serious problems for the system.

From the foregoing, some of the above-described examples of parallel power supply systems can only use the redundant control method to avoid the module-level failure, but they cannot obviate the risks of system-level single point failure; some of the examples though try to enhance the redundancy in system-level failure, but they use very complicated method, and waste lots of control resources, thus result another kind of system-level failure. The conventional methods therefore cannot provide excellent fault tolerance in parallel operation. A more advanced solution is needed for controlling the synchronous operation of UPS modules connected in parallel.

### SUMMARY OF THE INVENTION

The main object of the present invention is to provide a method for controlling parallel operation of a modular uninterruptible power supply (UPS) system, with units possessing full uninterruptible power supply capabilities and identical control logic and functional capabilities for self-initiated role detection, master arbitration and parallel processing, so as to enhance fault tolerance and redundancy management.

To this end, each UPS module is adapted to perform in the following functional modes:

Self-initiated role detection: this is mainly used for determining the functional role of the unit after the arbitration processes as a new entrant, virtual master or virtual slave.

New entrant operation mode: it first searches for a virtual master in the parallel UPS system. If the virtual master exists, it enters a wait for the virtual master to issue a call-slave command, and from which the local UPS module will switch itself over to the slave operation mode, but if the virtual master does not exist, it will initiate the master arbitration for electing a virtual master;

Master operation mode: it sequentially checks the status of new entrants and virtual slave in the system, and then requests response from the existing virtual slaves, and collects their operation data for controlling the parallel operation; and

Slave operation mode: it first checks if there is a virtual master in the UPS system, if it does not exist, it will change itself to become a new entrant, and then enter into the arbitration for new virtual master.

Using the above arbitration scheme, there will be only one virtual master in existence in the system at any given time, but when the virtual master is failed or inoperative in the network, other new entrants and virtual slaves will sense the loss of the virtual master, and they will change themselves from the virtual slaves to a new entrant mode to arbitrate for a new master through the arbitration process. This arbitration scheme participated by all UPS modules is capable to enhance the system redundancy and enhance system reliability.

The above UPS module, in accordance with the invention, further possesses a synchronous switching mode, such that when the virtual master detects that the system needs to be switched all at one point, it broadcasts a switch command to all parallel UPS modules requesting the same action by all UPS modules when the preset point is reached.

The above UPS module, in accordance with the invention, further possesses an optional wireless control mode. When the synchronous control line between the UPS modules experiences communication problem, the affected UPS modules can decide to switch to the wireless control of parallel operation.

The above-mentioned wireless control of parallel operation is implemented using a droop method, whereby respective UPS module collects data from the AC output to determine their active power and reactive power components, and then controls the resulting output phase and amplitude to regulate the output frequency and voltage to achieve load balancing. Respective UPS module may decide to shut down if internal problems develop.

The secondary object of the present invention is to provide a parallel power supply system with fault tolerance.

To this end, the system contains one or more UPS modules in parallel connection, and respective UPS module is built in with a microcontroller that is capable of performing parallel processing, and inter-unit signaling between all parallel UPS modules. The AC input, DC input, and AC output are connected in parallel with other UPS modules for controlling the parallel operation. Through a parallel control bus (PCB) connecting all parallel UPS modules, thus all parallel UPS modules can exchange operational data by inter-unit signaling for load balancing.

A typical UPS module contains an input filter, an AC/DC converter, a DC bus, a DC/AC inverter, a DC/DC converter connected between the DC input and DC bus, an optional charger, a power supply and a unit controller, wherein the power supply is to provide the power to operate the internal components in the UPS module; the unit controller is to control the operation of the local unit and coordinate the parallel operation of the UPS modules through the control bus.

The unit controller of respective UPS module is to control all functions of the local UPS module and the mode transition. The unit controller is built in with a digital signal processor (DSP) responsible for receiving and processing the input and output voltage signals and signals passed back from the frequency detection circuit, and signals returned by cross current detection circuit and load current detection circuit.

The parallel control bus is used for controlling the parallel operation of all UPS modules, which is composed of a photo-coupled bi-directional control line, a communication bus, and an analog signal synthesis line. In the photo-coupled bi-directional control line, one wire is used for configuring the virtual master. For example, if the virtual master is not in existence, the line shows high potential; otherwise it shows low potential. There is a sync clock line used for synchronizing the output phase of all UPS modules. The analog signal synthesis line is used for synthesizing the output current from all UPS modules.

The unit controller further includes general-use I/O functions, A/D conversion functions and capabilities. The signal processor is capable of using the feedback data from the DC bus voltage, AC output voltage, and cross conduction current from the inverters to control the AC output voltage and current to meet the load requirements.

The unit controller also provides power output calculation, as a safety measure, to protect the load, and the detection of cross conduction current derived between the inverters in parallel operation.

### BRIEF DESCRIPTION OF THE DRAWINGS

FIG. 1 is a block diagram of the overall architecture of the parallel power supply system in accordance with the present invention;

FIG. 2 is a block diagram of a typical UPS module;

FIG. 3 is a block diagram of a typical controller built in a UPS module;

FIG. 4 is a schematic circuit diagram of photo-coupled bi-directional communication bus in the controller;

FIG. 5 is schematic diagram of the analog signal synthesis line in the parallel power supply system;

FIG. 6 is a flow chart depicting the procedures for the self-initiated role detection mode for a UPS module;

FIG. 7 is a flow chart of the procedures for configuring a new entrant, including the virtual master arbitration process;

FIG. 8 is a flow chart of the procedures for configuring a virtual slave;

FIG. 9 is a flow chart of the first part of procedures for configuring a virtual master;

FIG. 10 is a flow chart of the second part of procedures for configuring a virtual master;

FIG. 11 is a diagram of an implementation of the wireless control of parallel operation for UPS modules in parallel with inductors respectively coupled to the output of the inverters; and

FIG. 12 is a flow chart for determining whether to use wire bus control or wireless control of parallel operation.

### DETAILED DESCRIPTION OF THE PREFERRED EMBODIMENT

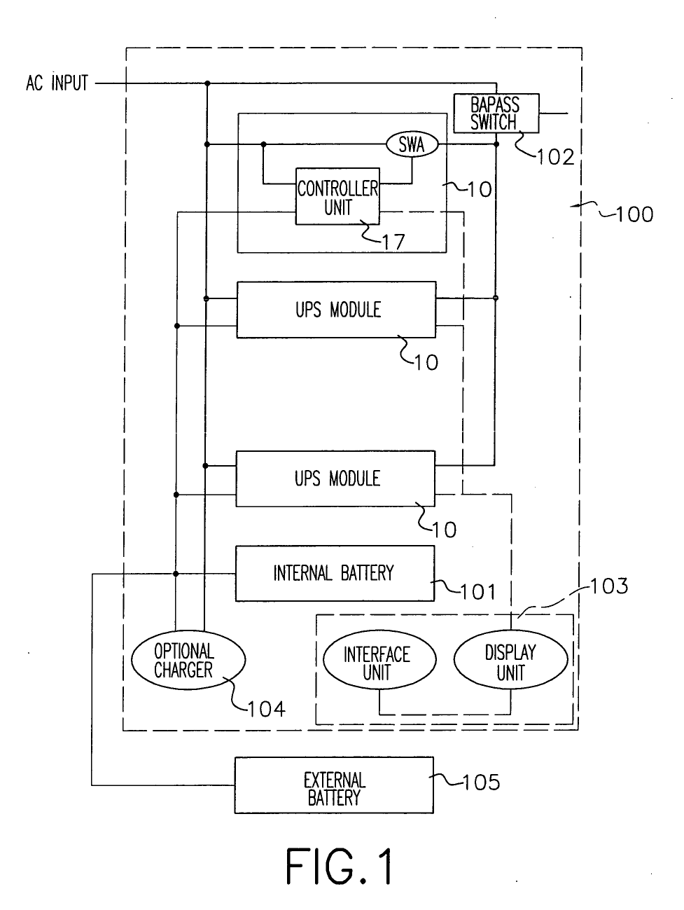

The present invention provides a modular uninterruptible power supply (UPS) system (100) containing one or more UPS modules (10) connected in parallel structure, as shown in FIG. 1. Each UPS module (10) has a unit controller (17) for controlling multi-mode switching and parallel operation with other UPS modules by connecting AC input, DC input and AC output in parallel with other UPS modules (10). A parallel control bus (PCB) is used for inter-unit signaling for exchanging operational data with unit controllers (17 of other UPS modules (10) for coordinating the parallel operation.

Each UPS module in the power supply system possesses identical control logic and functional capabilities for self-initiated role detection, master arbitration, parallel processing. Each UPS module is able to support the self-initiated role detection mode, new entrant mode, virtual master mode, and virtual slave mode.

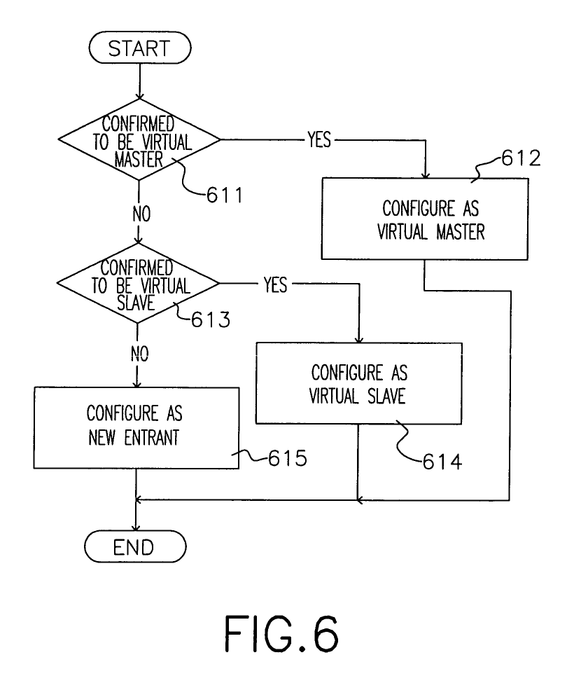

The procedures for operating the UPS module in the self-initiated role detection mode are illustrated in FIG. 6, covered by steps (611)-(615). When first started, the UPS module (10) has to determine if the unit should be a virtual master, virtual slave or a new entrant by taking part in arbitration, and then configures for the confirmed role accordingly.

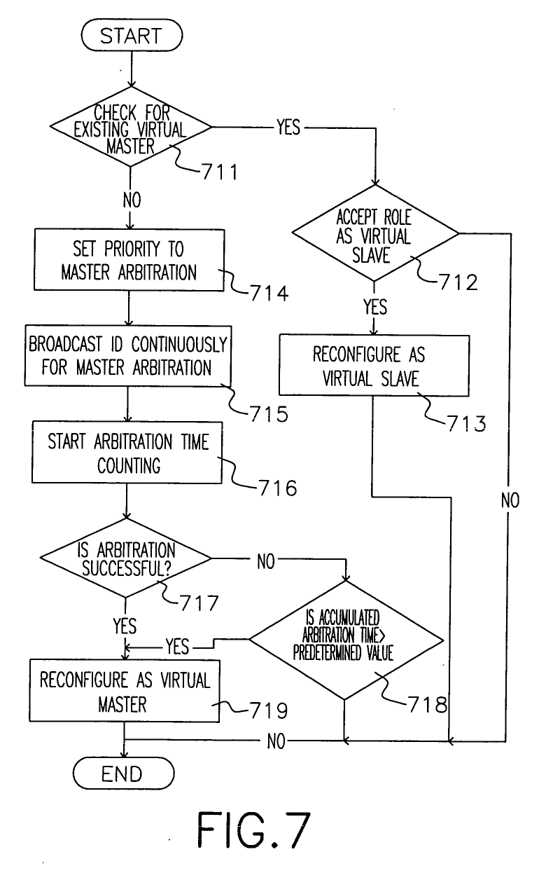

The procedures for configuring the UPS module in the new entrant mode are illustrated in FIG. 7. The program covers a master arbitration and single-unit operation mechanism. For a UPS module (10) being added to the power supply system (100), before confirming the role setting, the new UPS module is initialized as new entrant. The new UPS module first checks if a virtual master exists in the power supply system (71 1). If the virtual master is in existence, it will wait for the virtual master to issue a call-slave command (712), which is a routine check effected by an interrupt routine.

After receiving the call command from the virtual master, the new UPS module configures itself as a virtual slave (713), and terminates the checking process. If the call command doesn't come till the end of the interrupt routine, the new UPS module will terminate the checking process and directly enter into a wait for the call command from the virtual master. On the other hand, if the new UPS module detects that the virtual master does not exist, that means there are one or more UPS modules paralleled in operation. The new UPS module is assigned a priority to arbitrate in the master arbitration (714). The new UPS module then broadcasts the manufacturer's ID code continuously to other parallel UPS modules to arbitrate for the virtual master (715) and then checks the returned data if it contains the same content as the one issued before. In the present embodiment, the system makes use of the hardware and software characteristics of the control area network (CAN) for transmitting signals. Supposing two or more UPS modules in the system simultaneously send out messages containing an ID code to arbitrate for the virtual master, the one with low potential will win the arbitration, and will receive the original message containing its own ID, whilst other UPS modules will be configured to be the virtual slave. If there is only one UPS module in operation, in that case it will not be able to receive the own message echoed back, but after a predetermined time of arbitration is over, and no one asserts to be the master, it will directly configure to be the virtual master (716-719), that means there is only one UPS module operating in the system (719).

In the master-arbitration process, it is only necessary to identify the ID code without adding or multiplying any calculating time base, thus the actual time needed for virtual master-arbitration time would only take 1.5 ms, as in the present embodiment, even taking the battery operation mode into consideration the arbitrating time would take no longer than 3.0 ms. Having the slew rate appropriately controlled, the arbitrating process will not affect the AC output. However, this is a fast way to initialize the system and to pick a virtual master among the peers without wasting too many CPU resources.

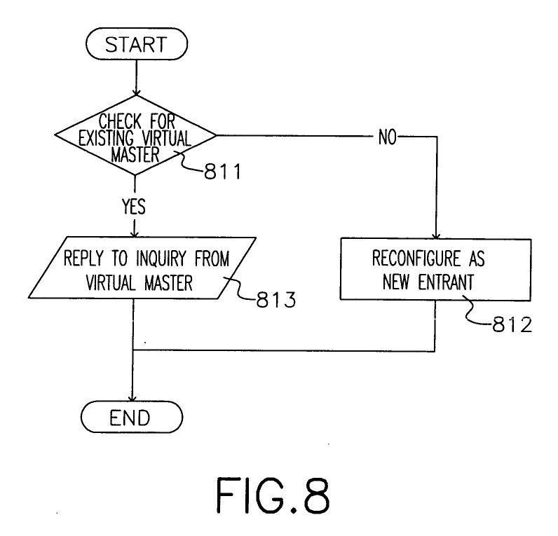

In FIG. 8, the procedures for configuring the UPS as the virtual slave are illustrated. The UPS module configured as a virtual slave first checks if a virtual master is in existence (811). If for some reason the virtual master does not exist, the same UPS module will immediately changes itself to become a new entrant (812), and arbitrate for a new virtual master; otherwise, that means the virtual master already exists, so it will enter a wait for the call command from the virtual master and then will make a response (813) accordingly.

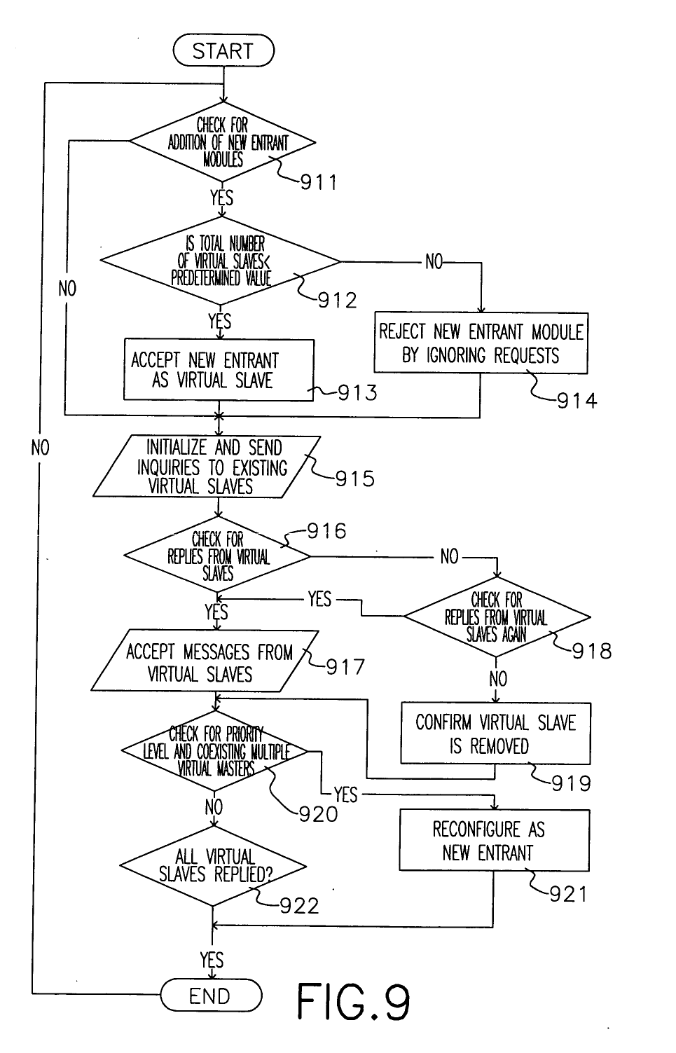

In FIG. 9, the flow chart for configuring the UPS module as a virtual master is illustrated. A UPS module configured as the virtual master first checks if any new entrant is added to the system (911); if this is true, it will then determine if the number of virtual slaves in the current system is less than the predetermined number (912). If this is true, the newly added UPS module will be assigned to be the virtual slave (913), but if the number of existing virtual slaves is greater than the predetermined number, the new entrant will be rejected by ignoring its requests (914). This situation will happen only when the system reaches the predetermined number that the system could take no more.

After having finished checking for new entrants, the virtual master checks the current status of virtual slaves (915) by sequentially inquiring all virtual slaves (916). If a virtual slave gives a response (917), that means the virtual slave is in existence; otherwise, the virtual master will try once more with an inquiry (918) trying to confirm if the virtual slave has been removed (919). The UPS module then it checks the priority assigned and checks if there is more than one virtual master (920) in existence. The former action is to check if the virtual master for some reasons has switched over to the battery mode, while some virtual slaves in the system are still operating in the power mains mode. If that is true, the virtual master configures itself to be a new entrant and reinitiates the master arbitration (921), such that one of the UPS modules in the power mains mode will be able to become the new virtual master. The latter action is necessary to prevent abnormal conditions from developing in the system, when all the virtual slaves have finished with their responses (922), the program will be terminated.

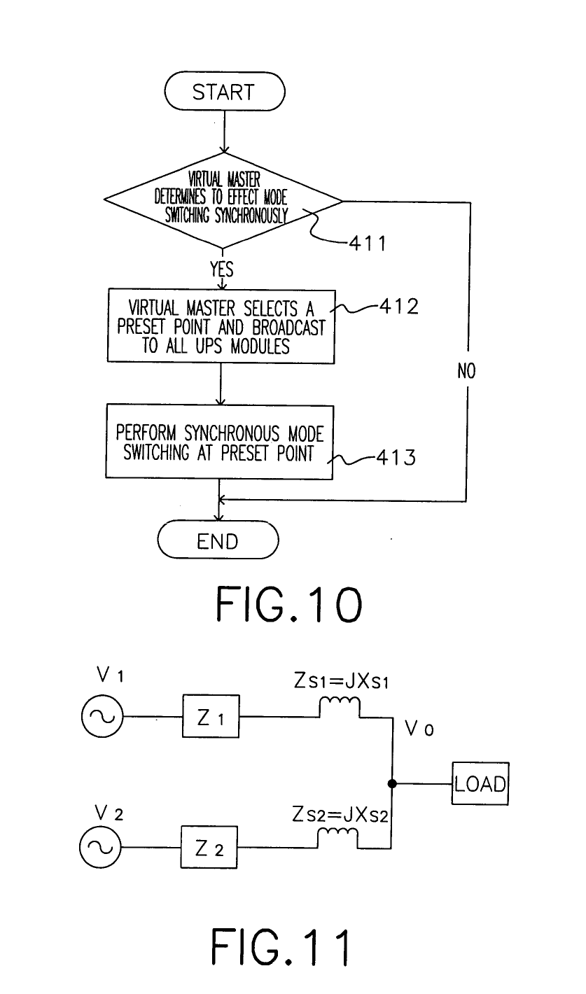

Besides the functional modes described above, the UPS module (10) is built in with the capability of synchronous switching mode. The detailed flow chart is shown in FIG. 10. The virtual master first checks if the system needs to be switched over all at once, and prepares itself for such switching (411), then the virtual master broadcasts synchronous switching commands received by itself, all virtual slaves and all new entrants (412), and then it will perform synchronous switching mode at a preset point (413), which generally refers to the zero crossing point of output voltage for triggering the synchronous switching.

The so-called synchronous switching in the present context can be subdivided into emergency and non-emergency cases. The decision to use either case rests in the virtual master, or it could be decided by individual UPS modules. The emergency case generally refers to a situation of bypass due to overload. When the virtual master determines that the system approaches overload, and the main line operates in the normal range, the system decides to switch all UPS modules in the system from the inverter output to the bypass output all at once. In the other hand, for the non-emergency case of the present embodiment, if the switch mechanism is implemented within a double-conversion structure, whereby the switching between power main and battery will not cause power interruption for the load. For the system, it would be more ideal if the switching decision can be made at the unit level without affecting other UPS modules, which at that time may be in a different situation. Supposing part of a UPS module is inoperative, the virtual master responds by switching all UPS modules at once, therefore this action will result in more disorders for the UPS system.

The UPS modules in the system are further provided with an optional wireless control mode. If it is found that the wire-control bus is not functioning normally, the UPS module can decide to switch to wireless control to maintain the parallel operation. The general concept of wireless control is depicted in FIG. 11. The output of the inverter is coupled with an inductor in series. The output voltage and frequency can be regulated by appropriate control of inductance therein. The required voltage and frequency difference between successive voltage signals can be computed for determining the active power and reactive power components, using the formulae given below:

$$\begin{matrix}{P}_{i} = \frac{{V}_{i} {V}_{o}}{{X}_{s1}} sin {δ}_{i} , & i = 1 , 2 , … , n \\ {Q}_{i} = \frac{{V}_{i} {V}_{o} cos {δ}_{i} - {V}_{o}^{2}}{{X}_{s1}} , & i = 1 , 2 , … , n\end{matrix}$$

Where δ represents the adjacent angle between V₀ and V₁.

From the above formulation, it can be found that active power is related to the output phase angle, and reactive power to the output amplitude. It is therefore possible to develop a control model for controlling the phase and amplitude of inverter output by an appropriate means, using the following relationship.
ωᵢ=ω₀ⱼ−k₁·Pᵢ, i=1,2, . . . ,n
Vᵢ=V_{0,i}−k₂·Qᵢ, i=1,2, . . . ,n

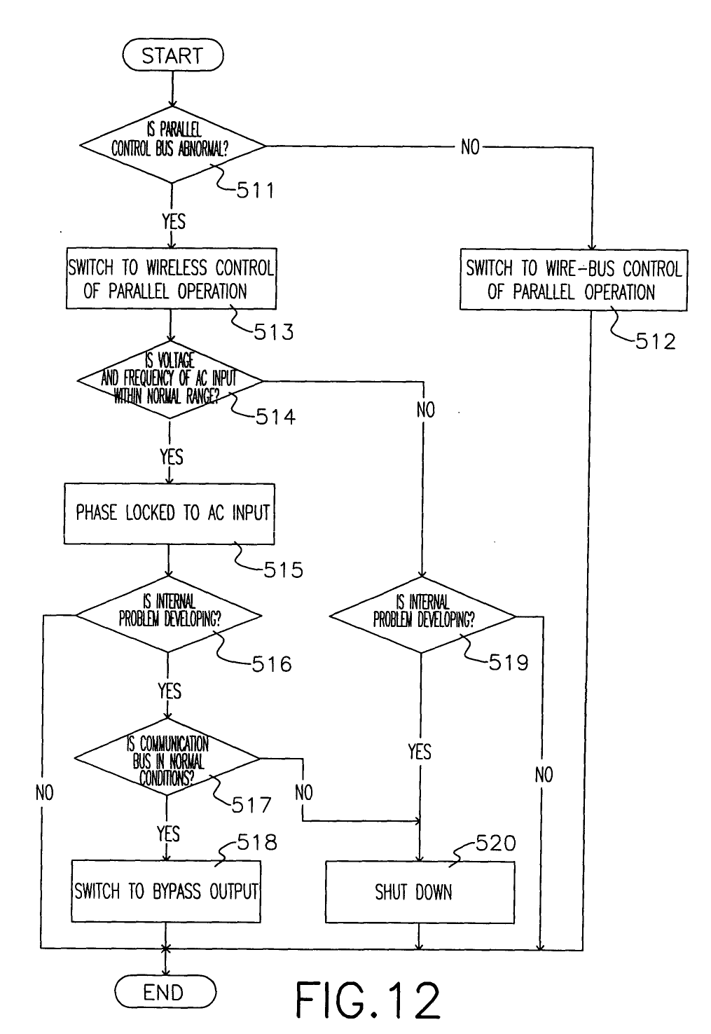

The above wireless control of parallel operation by the droop method is to use the feedback of the active and reactive power from the AC output of the UPS module to adjust the phase angle and the voltage amplitude of the AC output can be controlled by a phase-locked and amplitude-control loop. The control process in wireless mode is shown in FIG. 12.

Under the mode of wireless control of parallel connection, the UPS module first checks the parallel control bus if it is in normal condition (511), especially the master configuring line, sync clock line and/or analog signal synthesis line. If they are in normal conditions, the bus control mode will be maintained for the parallel connection and the procedures will be terminated (512). If the parallel control bus is found abnormal, the system will be switched over to the wireless control of parallel connection (513). It should be noted at this point the system still relies on the communication bus for electing a virtual master, which is to facilitate data display and manual control to switch to the bypass mode. The respective UPS module checks if the amplitude and frequency of AC input signals are within the normal range (514); if this is true, the output voltage will be phase locked to the AC input (515). The system then checks if an abnormal condition develops inside the UPS module (516). The system then proceeds to check if the communication bus is normal (517). If this is true, the system is capable to switch to the bypass under certain situations (518) and all procedures will be terminated. In the program, if the amplitude and/or frequency of AC input are not within the normal range, the output will not be phase locked to the input, and next it will check if an abnormal condition develops in the UPS module (519). Regardless of whether the communication bus is normal or not, it will not be able to switch to the bypass, and the UPS module will be shutdown (520). In another situation, if the amplitude and/or frequency of AC input are both within the normal range, but the communication bus is abnormal, it is necessary to confirm if an abnormal condition develops in the UPS module, which then leads to unit shutdown.

According to the above-mentioned method, the present invention employs a dynamic process to elect a virtual master among the UPS modules, which is responsible for controlling the parallel operation of UPS modules. In case that the communication bus is inoperative, the system further provides a way for switching to wireless control of parallel operation. This special feature is unparalleled in other control techniques. Equipped with the wire-bus control for the normal bus conditions and the wireless control for the abnormal bus conditions, the overall reliability of the UPS system is substantially enhanced.

From the present invention, the preferred embodiment emphasizes a kind of hybrid central control method, utilizing the spirits of the distributed and central control method. This design makes the system more reliable than general full distributed or full central control design. First, the redundancy of the system is the number of the system, much better than only use the main external controller and the redundant external controller, which redundancy is only two. Second, in the present invention, no important control circuit is placed on so-called external controller, which may cause the system-level single point failure, and the reliability and fault tolerance is great and significantly enhanced. Third, there are only one virtual master and virtual slaves in the steady-state system; there is no need for so-called virtual vice-master, so only one UPS module is in operation at any given time, and thus the system is provided with better flexibility. Fourth, in this invention, better resources arrangement, and wire/wireless bus is both equipped to enhance the reliability and availability. From these mentioned characteristics, this invention discloses a superior control method, which improves the redundancy, fault tolerance, and flexibility of the prior design and similar type power supply.

The basic architecture of the power supply system (100) will be described as FIG. 1, comprising:
one or more battery units (101) for extending the discharging time;
a manual bypass switch (102)for maintenance and repair use;
a display and communication unit (103) for providing meaningful data to users with regard to the internal operation and for monitoring the software programs;
an optional charger (104) for charging the battery; and
an optional output transformer (not shown in diagram) for changing the output voltage.

In the present embodiment, the output of the respective UPS module is connected in parallel, which allows the load capacity to be increased and provides the necessary system redundancy. It is possible to couple an isolation transformer (not shown) to the AC output bus, which is mainly used for decreasing the output voltage for low-voltage applications, such that many electrical devices and harnesses will be able to reduced to match the power requirements.

The AC input of the respective UPS module, as in the preferred embodiment, is adapted to receive an AC input with a plurality of phases, allowing expansion to suit larger power requirements. The UPS module (10) can be connected by a plurality of wires and switches, such that the AC input with one or more phase can be adapted to use the same UPS module.

The DC input of the respective UPS module, as in the preferred embodiment, comes from one or more internally installed batteries (101) or external batteries (105), The number of batteries can be controlled to match the unit discharging time required by the system. If the discharging time does not need to be extended, the batteries are not required to be connected in parallel, without affecting the output from the parallel power supply system. In the preferred embodiment, the AC inputs of all UPS modules are connected in parallel to an external battery (105) for extending the discharging time.

The display and communication unit (103) is to communicate with the elected virtual master, and for displaying meaningful information with respect to the control system through an LCD or LED monitor, and the display and communication unit (103) also act as an interface between the system and external devices through RS232, RS485 or SNMP to facilitate system reconfiguration or remote control. The unit also is capable of issuing sync clock signals as an external clock.

The optional charger (104) is installed when the charging capability needs to be boosted. The charger (104) can be connected with the internal optional charger (not shown in the diagram) in respective UPS modules (10) in parallel for boosting the charging current of the battery.

The manually operated bypass switch (1 02) is installed only if necessary, such as in situations that all UPS modules need to be removed, by providing a bypass for power supply to the load.

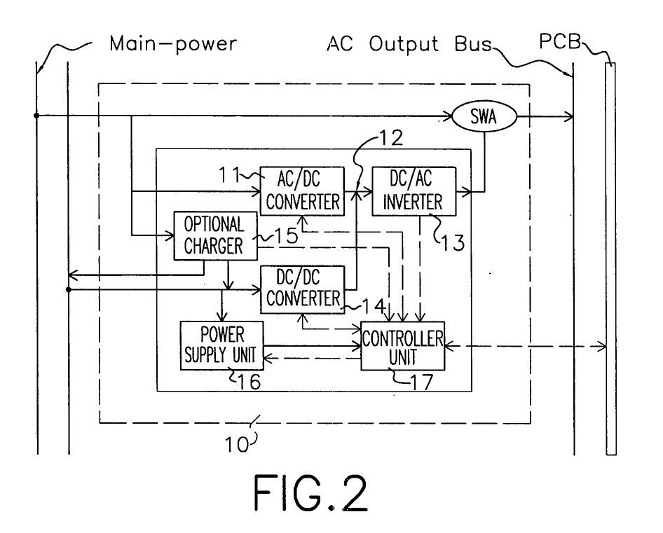

The architecture of a typical UPS module (10) is shown in FIG. 2, comprising:
an optional input filter (not shown in the diagram) being connected to the AC input;
an AC/DC converter (11) being connected to the output of the filter for converting AC to DC;
a DC bus (12) being connected both to the output of the AC/DC converter (11) and DC/DC converter (14);
a DC/AC inverter (13) being connected to the DC bus (12);
a DC/DC converter (14) being connected to the DC input, and the output is connected to the DC bus (12);
an optional charger (15) being connected to the AC input;
a power supply unit (16) being connected to the DC input and the optional charger providing the operating voltage for the unit;
a unit controller (17) being respectively connected by the DC/AC inverter (13), AC/DC converter (11), and DC/DC converter (14) for controlling the operation of the UPS module and for controlling the parallel operation.

Under the above structure, when the main line is in normal conditions, the AC input is the main source of electrical power, which is then fed through the AC/DC converter (11) converting from AC to DC voltage and onto the DC bus (12), and further through the DC/AC inverter (13) converting DC to AC output and onto the AC output bus, forming a double conversion parallel framework.

When the main line is failed, the power source is switched to the secondary DC power, and through the DC/DC converter (14) converting to high voltage DC onto the DC bus (12), and then through DC/AC inverter (13) converting DC to AC output and onto the common AC output bus.

The power for the internal operation of the unit is mainly supplied by the charger (15) and the internal battery (101) or externally connected battery (105), regardless of the power source (AC or DC). This provides the power for operating devices such as fans, microprocessors, and the power switches.

The switch (SWA) shown in the diagram refers to the AC from the DC/AC inverter (13), and the switch over from AC power coming from the AC input. The switching speed equals to the mode transition time. For each UPS module, it first puts the AC input, DC input, and AC output connected to other UPS modules (10), and then the controller (17) through the parallel control bus to exchange signals with other controllers (17) in other UPS modules (10) to accomplish load balancing and system stability.

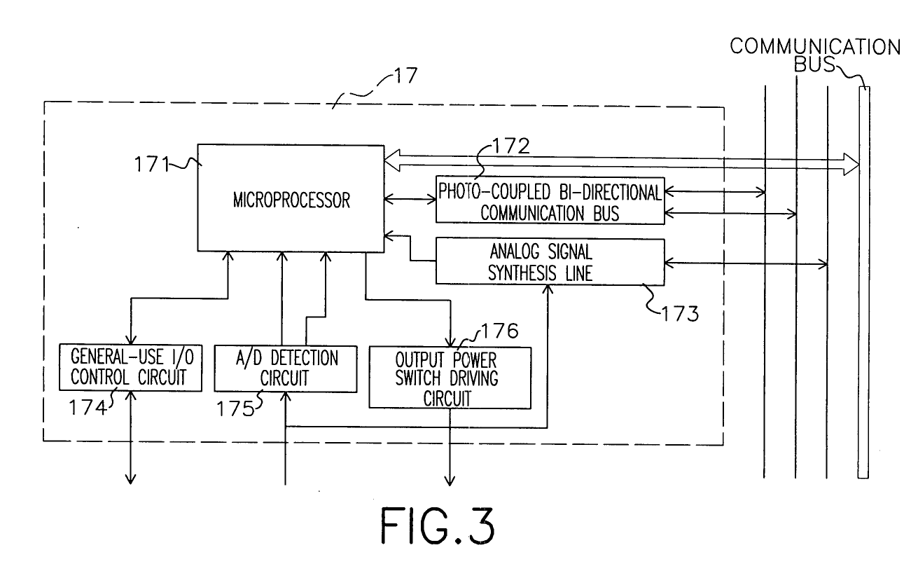

The unit controller (17) as in one of the operational models shown in FIG. 3 comprises:
a microprocessor (171) with digital signal processor (DSP) capability, and built in with multi-mode functions as shown in FIGS. 6-10. The controller (17) further includes a general-use I/O control circuit (174), an A/D detection circuit (175), an output power switch driving circuit (176), being respectively connected to the AC/DC converter (11), DC/DC converter (14), charger (15) and DC/AC inverter (13);
a photo-coupled bi-directional communication bus (172);
an analog signal synthesis line (173) being connected to the microprocessor (171) for synthesizing the output current from UPS modules (10);

In the present embodiment, the microprocessor (171) acts as the central control unit for the UPS module (10). To accomplish load balancing, the microprocessor (171) performs a range of signal detection for output voltage, output current, and cross conduction current from the DC/AC inverter (13), and internal computation to produce the required PWM duty cycle, and through the output power switch driving circuit (176) it controls the output power switch of the DC/AC inverter (13) to generate the required output voltage and current. The microprocessor (171) computes the duty cycle of output power of inverter based on the control data from the feedback output voltage and current and the feed forward AC output current and voltage.

The controller (17) of the respective UPS module (10) can obtain the data with respect to the total load current through the microprocessor (171), and pass them to the microprocessor with impedance matching for computation of the total load current.

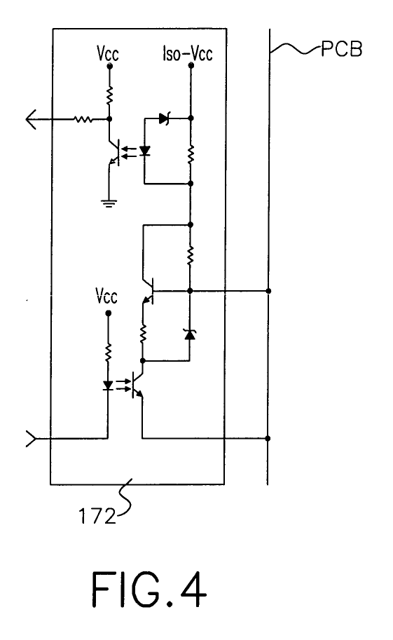

The photo-coupled bi-directional communication bus (172) can be used for configuring the virtual master and for transmission of sync clocks. One of the operational models of the photo-coupled bi-directional communication bus is shown in FIG. 4 comprising two photo-couplers, and a plurality of transistors and resistors respectively connected to the input and output terminals of the microprocessor (171) of the UPS module (10), such that the built-in microprocessor (171) is able to perform synchronous signal transmission and reception in both directions. The time delay factor in signal transmission can be incorporated into the computation model, so that the microprocessor (171) sending out the signal is able to receive the same message issued before. For the virtual master, one of the signal wires of the photo-coupled bi-directional communication bus (172) is used as a sync clock line, directly connected to the input capture of the controller (17) for frequency detection, such that all UPS modules (10) can be synchronized in identical phase.

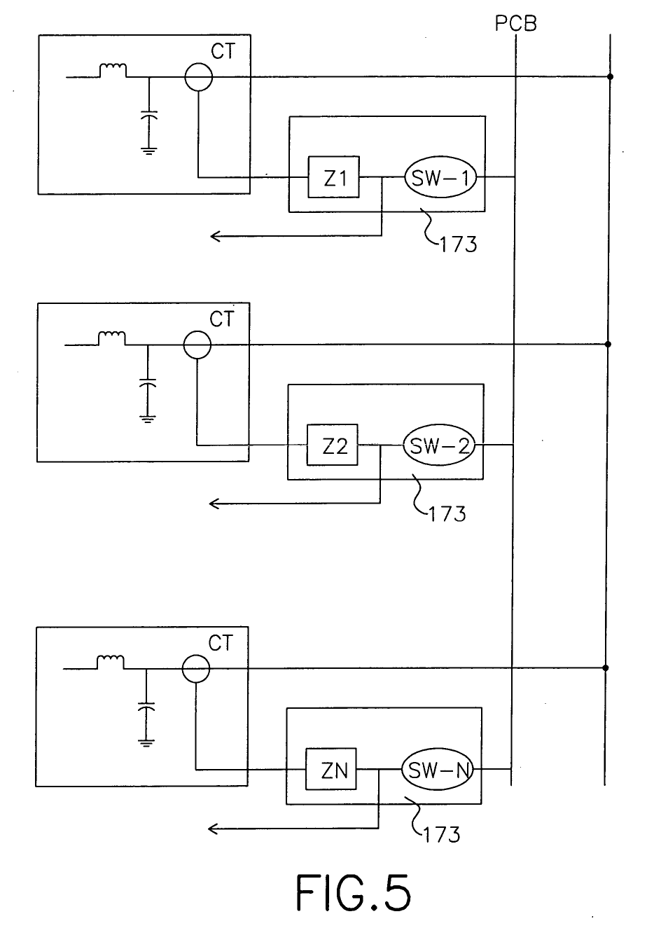

An example of the analog signal synthesis line is shown in FIG. 5. The respective UPS module can use a current transformer to extract the current waveform, and the microprocessor (171) through synthesis with appropriate impedance matching (Z1-Zn) to produce the required power distribution signal for sharing the load. The analog signal synthesis line (173) further includes a switch (SW1-SWn). When the system only has one UPS module operating or being switched to wireless control of parallel operation, the switch (SW1-SWn) is used to disconnect the respective UPS module (10) from the parallel control bus.

The above-mentioned parallel control bus is used for electing a virtual master through the master arbitration participated by one or more parallel UPS modules connected in parallel as already described in detail through FIGS. 6-10.

The present invention introduced the mixed control method, using the built-in redundant control logic in each respective UPS module to perform role detection, mode switching, and master arbitration. When the virtual master is down or failed, other UPS modules will be able to re-elect a new virtual master through the arbitration process, thus reducing the risk of single point failure.

The present invention design has adequately taken into consideration the necessary redundancy for parallel operation. Since the virtual master is dynamically elected from among all the UPS modules, the number of is equal to the total number of UPS modules in the system. The redundancy factor in this case should be higher than that with only a redundant units and dedicated controllers such as U.S. Pat. No. 6,201,319, thus decreasing the risks of a system-level failure of single-point failure.

Furthermore, there is only one virtual master to coordinate the operation of a plurality of virtual slaves, and the architecture of this invention constructs simpler structure compared to the prior art U.S. Pat. No. 6,396,170, which system is operated by dynamically selecting one UPS module to be the master dispensing with the vice master. Due to the compact and robust skill in this invention, the possibilities of the system-level single point failure could be decrease to as low as possible. Furthermore, since there are only one virtual master and virtual slaves, the so-called virtual vice-master is not necessary in this invention, such that even only one module could sustain the system in normal operation. Therefore, the availability and flexibility is better than the prior art U.S. Pat. No. 6,396,170, which both master and vice-master much exist in the system, and system could be normally operated. Only one module is not possible to make the system operate in the prior art. From the above mentioned characteristics, the present invention provides a more effective control method for controlling parallel operation of UPS modules with due consideration of redundancy, fault tolerance and flexibility.

The present invention has constructed the system with a simple structure using fully redundant UPS modules, without external control circuitry or dedicated controllers, as opposed to the case of prior art which employs a dedicated controller in conjunction with a redundancy intelligence management (RIM) for redundant control, and in another case in prior art the inventor uses a master, a vice master, peers method, and complicated-wasting-type parallel resource arrangement in the system.

The foregoing description of the preferred embodiments of the present invention is intended to be illustrative only and, under no circumstances, should the scope of the present invention be so restricted.

1. A method for controlling parallel operation of UPS modules by providing respective UPS modules with identical control logic and functional capabilities for self-initiated role detection, master arbitration, and parallel processing, and the capability to elect a virtual master among all the UPS modules for coordinating inter-unit signaling and controlling parallel operation, such that when the virtual master is found failed, all other parallel UPS modules will initiate a master arbitration to elect a new virtual master for coordinating the parallel operation.

2. The method for controlling parallel operation of UPS modules as claimed in claim 1, wherein respective UPS modules have functional capabilities to operate in the following operation modes:
self-initiated role detection mode used for determining the functional role of respective UPS module after the arbitration process as either a new entrant, virtual master or virtual slave;
new entrant operation mode wherein the UPS module first checks for a virtual master in the parallel UPS system and if the virtual master exists, the respective UPS module will enter a wait for the virtual master to issue a call-slave command, and from which the respective UPS module will switch itself over to the slave operation mode; but if the virtual master does not exist, the respective UPS module will initiate the master arbitration for electing a virtual master;
master operation mode wherein the elected master sequentially checks the status of new entrants and virtual slave in the system, and then requests a response from the existing virtual slaves, and collects their operation data for controlling the parallel operation; and
slave operation mode wherein the UPS module checks for a virtual master in the UPS system; if it does not exist, the respective UPS module will change itself to become a new entrant, and then enter into the arbitration process for new virtual master.

3. The method for controlling parallel operation of UPS modules as claimed in claim 2, wherein the respective UPS module further possesses the functional capability of synchronous mode switching, in situations where the system needs to be switched over all at once at a preset point.

4. The method for controlling parallel operation of UPS modules as claimed in claim 3, wherein the respective UPS module further possesses the functional capability of an optional wireless control mode, in situation where the interconnecting communication bus is inoperative the respective UPS module can decide for itself to switch over to wireless control of parallel operation.

5. The method for controlling parallel operation of UPS modules as claimed in claim 4, wherein the wireless control is implemented using a droop method, whereby the respective UPS module uses the feedback data from the output of the UPS module to determine if its output contains more active power or reactive power, and from which the phase angle and amplitude of the output voltage signal can be controlled by an appropriate means.

6. The method for controlling parallel operation of UPS modules as claimed in claim 2, wherein the respective UPS module operating in the new entrant operation mode is able to arbitrate for the virtual master by broadcasting the manufacturer's ID code onto the communication bus; if the received data is found to contain the same ID code as that previously sent out, the respective UPS module will configure itself to be the virtual master in the system.

7. A modular uninterruptible power supply (UPS) system including one or more UPS modules connected in parallel, wherein a respective UPS module comprises:
one or more DC inputs and AC input phases;
one or more AC output phases;
an AC output being connected in parallel to the load;
a unit controller with the functional capabilities for self-initiated role detection, mode switching, and master arbitration through the parallel control bus; and
a parallel control bus for controlling the operation of the local unit and coordinating the parallel operation.

8. The modular UPS system as claimed in claim 7, wherein the system further includes:
a display and communication unit for providing meaningful data to users with regard to the internal operation and for monitoring software programs;
an optional external battery being connected to the DC input for extending the discharging time;
an optional charger for charging all the batteries;
an optional output transformer being connected to the output of the UPS module; and
an optional manual bypass switch being installed between the inputs and outputs of the UPS module.

9. The modular UPS system as claimed in claim 7, wherein the AC input voltage should possess a plurality of phases in one cycle, whereby the UPS module can be connected by a plurality of wires and switches to adapt to a multi-phase AC input.

10. The modular UPS system as claimed in claim 7, wherein the DC input comes from batteries, which can be installed in the UPS module, or externally connected to the UPS module.

11. The modular UPS system as claimed in claim 7, wherein the unit controller of the respective UPS module further comprises a general-use I/O control circuit, whereby the unit controller is able to control the output power switch of AC output and the parallel control bus basing on the feedback of voltage and frequency signals from the DC bus, DC input, AC input and AC output, and AC input, and output current, and conduction current from the inverters.

12. The modular UPS system as claimed in claim 11, wherein the unit controller further includes a microprocessor for controlling I/O operations, output power switch using the feedback voltage and current data from AC output, and the inter-unit signaling switch.

13. The modular UPS system as claimed in claim 11, wherein the unit controller further includes a photo-coupled bi-directional control bus, a communication bus and an analog signal synthesis line.

14. The modular UPS system as claimed in claim 13, wherein the photo-coupled bi-directional control bus has one wire used for configuring the virtual master, and another wire for transmitting sync clocks from the virtual master to synchronize the parallel operation.

15. The modular UPS system as claimed in claim 13, wherein the photo-coupled bi-directional control bus has incorporated impedance matching on the input and output terminals.

16. The modular UPS system as claimed in claim 14, wherein the sync clocks are directly passed to the input capture of the unit controller for detecting input and output frequencies.

17. The modular UPS system as claimed in claim 15, wherein the sync clocks are directly passed to the input capture of the unit controller for detecting input and output frequencies.

18. The modular UPS system as claimed in claim 13, wherein the analog signal synthesis line includes a switch for controlling the synthesis of output current from UPS modules connected in parallel in accordance with a predetermined ratio, and the switch is disconnected if found not necessary.

19. The modular UPS system as claimed in claim 7, wherein the display and communication unit is hot swappable, and acts as a source for sync clock signals received by all parallel UPS modules.

20. A UPS module in a modular power supply system has a power unit, comprising an AC/DC converter, a DC/DC converter, a DC bus and a DC/AC inverter; and
a unit controller built in with the functional capabilities for self-initiated role detection, master arbitration, and parallel processing, and including an I/O control circuit and parallel control bus, wherein
the I/O control circuits detect the voltage and frequency of AC input, voltage of DC input, and voltage, current and frequency of AC output for controlling the output power switch of AC output.

21. The UPS module as claimed in claim 20, wherein the UPS module further includes an optional charger and a power supply unit.

22. The UPS module as claimed in claim 20, wherein the UPS module further includes a microprocessor for controlling the inverter operation in either standalone or parallel connection mode, computing the required duty cycle for the output power switch, detection of voltage and frequency signals from both input and output, and inter-unit signaling between UPS modules during parallel operation.

23. The UPS module as claimed in claim 20, wherein the unit controller has a parallel control bus formed by an analog signal synthesis line, a photo-coupled bi-directional control bus and a communication bus, whereby the respective UPS module is able to maintain the parallel connection with other parallel UPS modules.

24. The UPS module as claimed in claim 22, wherein the UPS module can use the microprocessor and the parallel control bus to elect a virtual master through an arbitration process to be responsible for synchronizing the output of all parallel UPS modules.

25. The UPS module as claimed in claim 23, wherein the photo-coupled bi-directional control bus is used for receiving signals from other parallel UPS modules or transmitting signals to other UPS modules.

26. The UPS module as claimed in claim 25, wherein the photo-coupled bi-directional control bus has a wire used for transmission of sync clocks to the input capture of the microprocessor in the unit controller.
